(19) United States
(12) Patent Application Publication
(10) Pub. No.: US 2011/0155343 A1
(43) Pub. Date: Jun. 30, 2011

(54) HEAT OR ENERGY RECOVERY HOUSING AND SEALING SYSTEM

(75) Inventors: Patrick Paul Boudreau, Dieppe (CA); George Robert Lestage, Grand Barachois (CA)

(73) Assignee: Air Tech Equipment Ltd., Boudreau-Quest (CA)

(21) Appl. No.: 12/671,807

(22) PCT Filed: Jul. 31, 2008
(86) PCT No.: PCT/CA2008/001403

§ 371 Date: Jun. 4, 2010

(30) Foreign Application Priority Data
Aug. 3, 2007 (CA) 2,596,146

(51) Int. Cl. F28D 17/00; F16J 15/53

(52) U.S. Cl. 165/10; 277/629

(57) ABSTRACT

A heat and energy recovery ventilator housing comprising at least one means for releasable sealing engagement of the at least one energy core to the housing and for providing an air tight seal between the at least one energy core and an interior of the housing, said sealing means positioned to prevent a leakage between the supply airflow and the exhaust airflow, is described. A sealing system comprising a gasket having a sealing surface and a rail having contact surface, said gasket attachable to an interior of the ventilator housing and said rail attachable to the core at a location in alignment with the gasket, the gasket and the rail, when positioned in alignment, magnetically cooperating thereby forming an airtight seal for preventing an air leakage between the supply airflow and the return airflow within the housing but outside of the core is also described. The ventilator housing and sealing system allows for the easy insertion and removal of a heat or energy recovery ventilator core while maintaining an airtight seal when the core is in place.

### RELATED APPLICATION

This application claims the benefit of Canadian Patent Application No. 2,596,146, filed Aug. 3, 2007.

### FIELD OF THE INVENTION

The present invention relates to ventilation systems, more specifically, the present invention relates to a housing for an energy or heat recovery ventilator and to a sealing system therefor.

### BACKGROUND OF THE INVENTION

Improvements in building construction standards, techniques and materials has led to the construction of well-insulated, more tightly built, leak-free structures. Such structures may experience poor air quality due to insufficient ventilation. Within the structure, the indoor air may become stale, being increasingly stuffy, having high humidity levels and a build-up of indoor pollutants such as odours, mould and mildew, tobacco, chemical fumes and combustion by-products, and the like. A ventilation system may be used for air exchange providing a continuous stream of fresh, outdoor air into a structure while exhausting the return indoor air from the structure, thereby improving air quality within.

In addition to air exchange, a heat recovery ventilator has the ability to transfer heat between an exhaust airflow and a fresh airflow. In the winter, heat from the return, exhaust air may be transferred to the fresh airflow, thereby “pre-heating” the incoming air. Conversely, in the summer, the return exhaust air may be used to cool the incoming, warmer fresh air. Such pre-treatment may help reduce the cost of heating or cooling the incoming fresh airflow.

An energy exchange ventilator has the ability to exchange both heat and moisture between exhaust and fresh airflows, thereby further regulating moisture levels within a structure. In the winter, heat and moisture from exhaust air may be transferred to the colder, drying incoming fresh air, thereby “pre-heating” and “humidifying” the incoming air. Conversely, in the summer, dry, air conditioned return exhaust air may be used to cool and remove moisture from incoming, warmer, humid fresh air. Such pre-treatment may help further reduce the cost of conditioning the incoming fresh airflow.

Typically, heat and energy recovery ventilators include a housing with a plurality of ducts: one set for drawing in and supplying fresh air into a structure, the other set used to exhaust return air outdoors. Fans are used to draw fresh air indoors and to circulate the air throughout the structure, for example, via ductwork and to draw and exhaust return air outdoors.

Heat exchange may occur in a heat-exchange, air-to-air core in the housing. Outgoing exhausted return air and incoming fresh air pass through one or more cores whereupon sensible and latent heat is transferred from one stream to another. In an energy recovery core, moisture is also transferred. Often, the cores are structured so that the airflows do not mix. This is advantageous, for example, where the incoming fresh air is filtered before it enters the core while the return air carrying pollutants is exhausted outside.

The housing helps position the cores in the ventilator in the path of the appropriate airflows. The cores may be removable, for example, for repair, cleaning or replacement.

However, during the course of development and testing of heat and energy recovery ventilators, it has been discovered that an amount of leakage and contamination between the supply flow of fresh air and the exhaust flow of return air may be experienced, for example, between the cores and their supports within the housing.

In order to reduce the amount of leakage between the two aforementioned airflows, it is advantageous to provide a sufficiently strong seal between the energy or heat recovery core and the housing of the ventilation system. While a strong seal is desirable, it is advantageous and desirable for the energy or heat recovery core to be removable, for cleaning, repair, replacement, and the like, for example. This removeability requirement generally precludes the use of any kind of adhesive between the core and the support structure.

As a consequence, there is a need for a ventilator housing that provides a strong seal between the energy and heat recovery core and the housing in order to minimize leakage and cross-contamination of airflows.

### SUMMARY OF THE INVENTION

In accordance with an aspect of the present invention, a heat or energy recovery core housing is provided. The housing has a plurality of ports connectable to a plurality of ducts for conveying a fresh airflow and a return airflow therethrough, the fresh airflow and the return airflow each passing through at least one heat or energy recovery core for heat and optionally moisture exchange therebetween without mixing. The housing comprises at least one means for releasable sealing engagement of the at least one energy core to the housing and for providing an air tight seal between the at least one energy core and an interior of the housing, said sealing means positioned to prevent a leakage between the supply airflow and the exhaust airflow.

In one or more embodiments, the means for releasable sealing engagement may be a magnetic gasket having a permanent magnet. The magnetic gasket may comprise a base, an elongated tubular magnet retainer having a contact surface and a permanent magnet within said magnet retainer. The contact surface forms a seal when in magnetic cooperation with a magnetisable surface, preferably a ferromagnetic surface. The contact surface may be substantially flat with the gasket further comprising a web connecting the base to the magnet retainer.

In other embodiments, the magnetic retainer is circular, semicircular or oval in cross-section or is rectangular or square in cross-section.

In another embodiment, the means for releasable sealing engagement comprises a magnetisable, preferably ferromagnetic, gasket. The gasket may have a ferromagnetic contact surface or may be partially or completely formed of ferromagnetic material.

In another embodiment, the housing may further include means for retaining the at least one heat or energy recovery core within the housing in the flow path of the fresh airflow and the flow path of the return airflow. The housing may include a top horizontal core support, a bottom horizontal core support, a back wall and a door, and at least one support means connected to the top core support for positioning a top part of the core within the housing and/or at least one bottom support means connected to the bottom core support for positioning a bottom part of the core within the housing. A magnet gasket may be provided on at least one top or bottom core support means for forming a seal between the top or bottom core and the adjacent top or bottom core support respectively.

In another embodiment, a ventilation system may include the housing which includes at least one removable heat or energy recovery core, the core having at least one metal railing positioned to align with at least one means for releasable sealing engagement of the core for forming an airtight seal therebetween. The railing may be L-shaped and may be formed of a magnetisable material, preferably ferromagnetic material. Alternatively, the railing may be a permanent magnet.

In another aspect of the invention, there is provided a sealing system for an energy recovery ventilator housing at least one energy recovery core within which heat and optionally moisture is exchanged between a supply airflow and a return airflow without mixing. The sealing system comprises a gasket having a sealing surface and a rail having contact surface, the gasket is attachable to an interior of the ventilator housing and the rail is attachable to the core at a location in alignment with the gasket. The gasket and the rail, when positioned in alignment, magnetically cooperating thereby forming an airtight seal for preventing an air leakage between the supply airflow and the return airflow within the housing but outside of the core.

In one or more embodiments, the gasket may be a magnetic gasket having a permanent magnet. The magnetic gasket may comprise a base, an elongated tubular magnet retainer having the sealing surface and a permanent magnet within said magnet retainer. The sealing surface is substantially flat and the gasket may further comprise a web connecting the base to the magnet retainer. The magnetic retainer is circular, semicircular or oval in cross-section or may be rectangular or square in cross-section.

In another embodiment, the gasket comprises magnetisable material, preferably being a ferromagnetic gasket. The gasket may have a ferromagnetic sealing surface or may be partially or completely formed of ferromagnetic material.

In another embodiment, the railing is L-shaped and may be formed of ferromagnetic material. Alternatively, the railing may be a permanent magnet.

The disclosed housing and sealing system provides a strong, airtight seal between the energy and heat recovery core and its housing for use in a heat or energy recovery ventilator. The seal may be readily broken for removal of a core. This may be accomplished with minimal cost and without affecting the ventilation system in any other way.

When used in conjunction with a design which is designed to be as air tight as possible, the present housing and sealing system helps to ensure an airtight seal between the energy or heat recovery core and the supports. This helps reduce the leakage in the ventilation system and the contamination of the fresh supply airflow with return exhaust air.

### BRIEF DESCRIPTION OF THE DRAWINGS

The invention and the illustrated embodiments may be better understood, and the numerous objects, advantages, and features of the present invention and illustrated embodiments will become apparent to those skilled in the art by reference to the accompanying drawings. In the drawings, like reference numerals refer to like parts throughout the various views of the non-limiting and non-exhaustive embodiments of the present invention, and wherein:

The present invention, in terms of a presently preferred embodiment, is illustrated in the attached drawings, wherein:

FIG. 1 is a top front perspective view of a heat or energy recovery core housing with the front cover shown in the open position;

FIG. 2 is a bottom front perspective view of the housing of FIG. 1 showing the underside of the housing;

FIG. 3 is a partially exploded view of the housing of FIG. 1 showing the energy recovery cores, illustrated schematically as rectangular blocks shown as removable from the enclosure;

FIG. 4 is a view of the energy recovery cores;

FIG. 5 is a front view of another embodiment of the housing with magnetic gaskets in place;

FIG. 6 is a front view of a magnetic gasket in accordance with an embodiment of the invention; and

FIG. 7 is a cross-sectional view of the magnetic gasket of FIG. 6.

### DETAILED DESCRIPTION OF PREFERRED EMBODIMENTS

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention pertains.

The term “duct” is intended to include any conduit, passage, pipe, tube or other elongated hollow body capable of carrying air. A duct may be formed by any type of suitable duct material, for example but not limited to, sheet metal, plastic, or the like.

The term “fan” is intended to include any instrument or device for producing a current of air, for example but not limited to, any device that comprises a series of vanes radiating from a hub rotated on its axle by a motor.

The term “cross flow” is intended to describe the direction of fluids, in the present invention the directions of the air, are substantially perpendicular to each other. However, it should be apparent to a person skilled in the art that the air flows of the present invention are not limited to form a cross-flow. Other examples with various degrees of efficiency may include, but not limited to, counter flow, parallel flow, or any other arrangement.

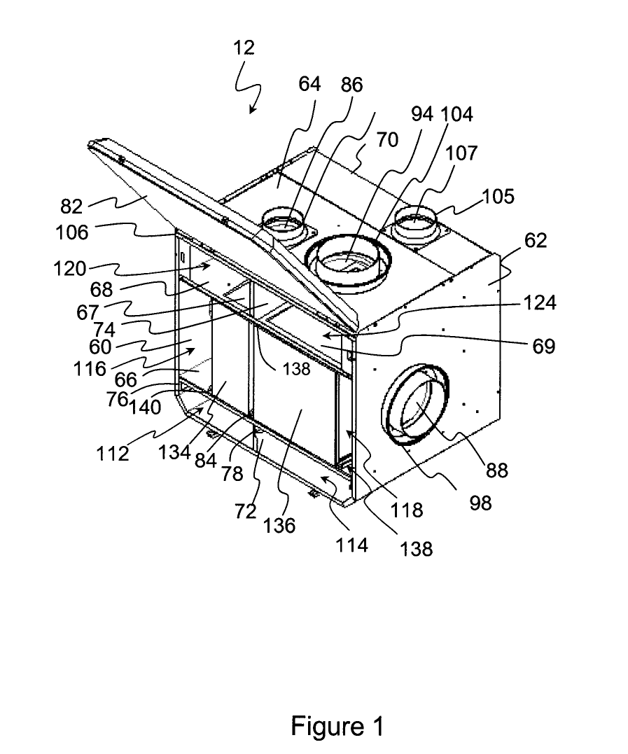

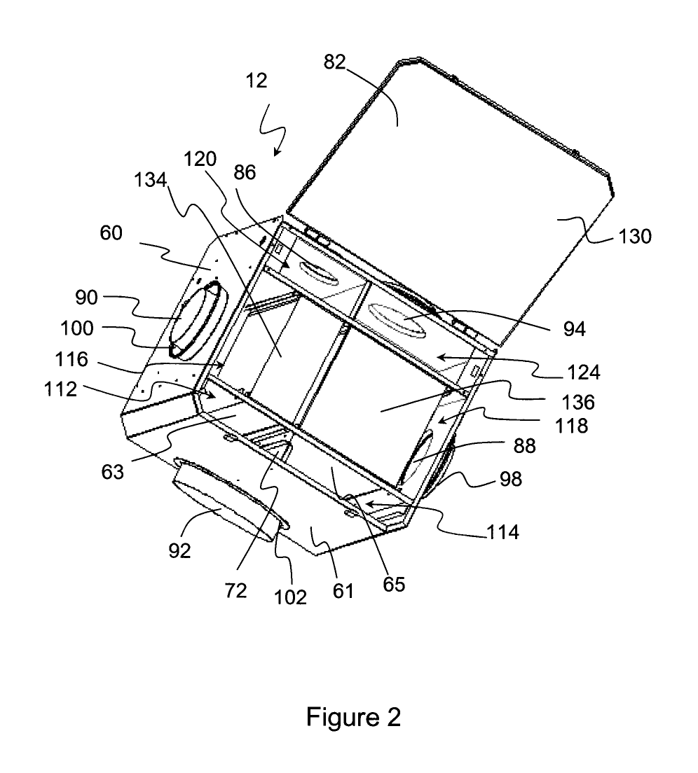

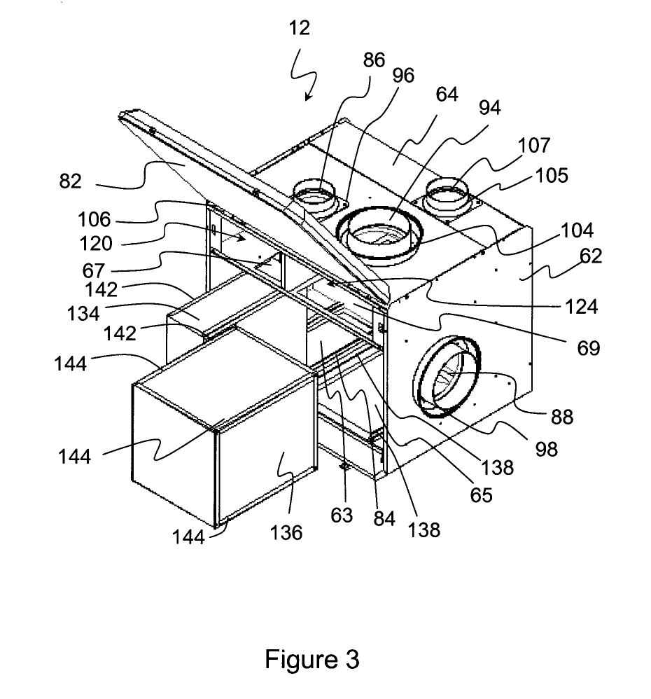

FIGS. 1, 2 and 3 depict various views of a ventilator in accordance with an embodiment of the invention. The ventilator housing 12 includes a pair of side walls 60, 62, a top wall 64, and a bottom wall 61, bottom horizontal core support 66, and a top horizontal core support 68 hold a first heat or energy recovery core 134 and a second heat or energy recovery core 136. The housing 12 also includes a removable back panel 70, a lower divider 72, an upper divider 74, a side filter support 76, a middle filter support 78, a door 82, and a core support 84 that releasably holds the second core 136 and the first core 134 in place. The bottom horizontal core support 66 has two openings 63, 65, and the top horizontal core support 68 has two openings 67, 69 for allowing air flow through the first core 134 and the second core 136, from port 92 to ports 86 and 94, respectively. As can be seen in FIG. 2, the port 92 straddles the divider 72 so that the intake air from port 92 is divided between the first core 134 and the second core 136.

It can be appreciated that the housing may releaseably hold one core or may releasably hold a plurality of cores without departing from the scope of the invention. Additionally, it can be appreciated that the housing may be adapted to releaseably hold different types of cores, including exchangers and sub-cores, of varying types and construction.

The housing 12 also includes a plurality of ports 86, 88, 90, 92, 94, each of which has a connector 96, 98, 100, 102, 104 connectable to various ducts. For example, a duct is connectable to port 88 for receiving and conveying fresh, outside air to the housing 12. Another duct is connectable to port 90 for conveying fresh, treated air from the housing to be circulated to various areas within the building structure. Another duct is connectable to port 92 to convey return air circulating from within the building into the housing 12. Another duct is connectable to port 104 to convey return air away from the housing 12 for exhausting outside of the building.

The housing 12 may have an additional port 86 with a connector 96. A duct is connectable to this port 86 for recirculation of return air within the building.

The housing 12 may further have an additional spare port 107 with a connector 105. A duct is connectable to this port 107 for further exhaust purposes.

As depicted, the housing is configured for a cross-flow, air-to-air type heat or energy exchanger. As depicted, a fresh air supply airflow flows into the housing, generally flowing from port 88 to port 90, through cores 134 and 136, with an exhaust airflow flowing into the housing, generally flowing from port 92 to port 94 and/or from port 92 to port 86 through either core 134 or 136. The core support 84, and bottom and top horizontal core supports 66 and 68 are positioned to maintain the cores 134 and 136 so as to permit fresh and return air to flow therethrough.

One or more cores within the housing may be positioned and configured to enable the transfer of sensible energy from one airflow to the other without transferring air through its medium, thus preventing the mixing of the two airflows. Moisture barrier sheets may be used to prevent the transfer of moisture between the two airflows.

Alternatively, one or more energy recovery cores, for example, an enthalpy recovery core, may be positioned and configured to enable the transfer of latent and sensible energy from one airflow to the other without transferring air through its medium, thus preventing mixing of the two airflows.

Additionally, filters may be provided, for example, adjacent port 88 to further filter the fresh supply airflow before flowing into the cores 134 or 136. Fresh air, having passed through cores 134 and 136 may also be termed treated air.

As aforesaid, the embodiment depicted in the figures are for a cross-flow, air-to-air type exchanger. Other examples of configurations with varying degrees of efficiency may include, but is not limited to, counter flow, parallel flow, or any other arrangement.

The door 82 is connected to the top wall 64 by a hinge 106, providing access into the housing including to the cores 134 and 136.

Foam interlays, for example, a bottom left foam interlay, a bottom right foam interlay, a lower side foam interlay, a lower rear foam interlay, an upper left rear interlay, an upper right rear interlay, a top right foam interlay, an upper side foam interlay, a top left foam interlay, may be inserted into the spaces 112, 114, 116, 118, 120, and 124. The door 82 may also include door foam insulation layer 130, and a door foam inner layer (not shown). The various foam layers may therefore cover all of the inner surfaces of the housing 12 and provide both thermal and acoustic insulation.

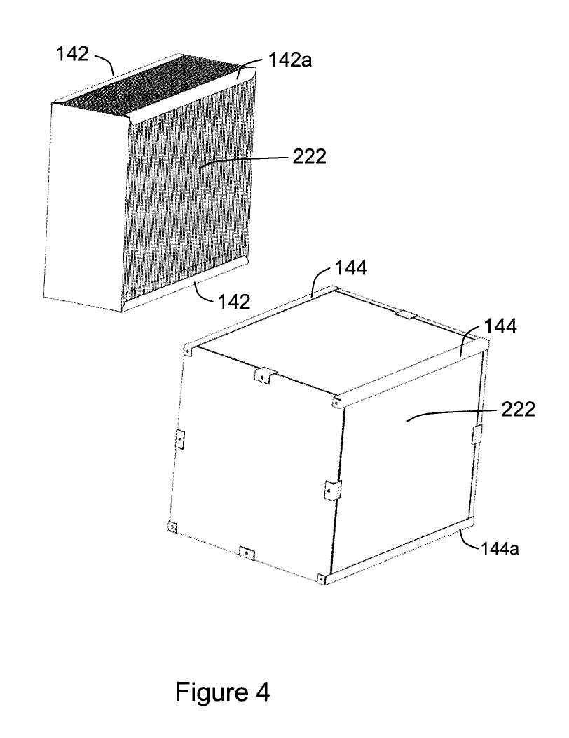

As aforesaid, the cores 134 and 136 are positioned within the housing 12 such that fresh airflow flowing from duct 88 to duct 90 and return airflow from duct 92 to duct 86 both pass therethrough. In the embodiment depicted in FIG. 4, the heat and energy recovery cores are cuboid, for example, in the shape of a cube or rectangular prism, and having substantially straight perimeter edges. The cores 134 and 136 are each sized and configured to nest substantially adjacent to one or more interior walls of housing 12, as depicted, the top and bottom horizontal core supports 68 and 66 respectively, and core support 84. Each core is dimensioned so as to facilitate placement of the core within the housing but also to permit certain perimeter edges adjacent to the interior wall be located proximately thereto so as to reduce or minimize the size of gaps therebetween through which air flow may pass.

As depicted in FIGS. 1 to 3, and 5, support means 146 and 148, for example, rails, brackets, plates, strips, formed ridges, ledges, or guides, or the like are provided within the housing 12 to assist in the positioning and retention of the core 134 in the housing 12 in the path of the fresh airflow and in the return airflow, as aforesaid. Similarly, support means 150 and 152 are provided within the housing 12 to assist in the positioning and retention of the core 136 in the housing such that fresh airstream flowing from duct 88 to duct 90 and return airstream from duct 92 to duct 94 both pass therethrough. Preferably, the support means are sized and shaped so as to contact the core along perimeter edges to minimize obstruction to airflow through the core.

A pair of support means 146 may be positioned on the top horizontal core support 68 to position and retain a top end of core 134 within housing 12 and a pair of support means 148 are positioned on the bottom horizontal core supports 66 to position and retain a bottom end of core 134. Correspondingly, a pair of support means 150 may be positioned on the top horizontal core support 68 to position and retain a top end of core 136 within housing 12 and a pair of support means 152 are positioned on the bottom horizontal core supports 66 to position and retain a bottom end of core 136. Such support means preferably extend fully from back panel 70 to door 82, perpendicular to the path of flow of the supply airflow, and is substantially air impermeable to reduce the amount of leakage of air flow between a core and an adjacent interior wall of the housing 12.

It can be appreciated that the number of such support means, if provided, and the placement thereof within the housing may vary based upon the number of cores used, the shape thereof, their positioning and their orientation within the housing. Support means, if present, may be provided to support perimeter edges of a core adjacent and proximate to an inner wall surface of the housing.

Alternatively, panels provided with knock outs or other openings may be used to retain and position the cores. Such panels may be similar to the top and bottom horizontal core supports 68 and 66. Such panels may be positioned perpendicular to and vertical relative to the top and bottom horizontal core supports 68 and 66. Such panels may be permanently affixed or slidably retained within the housing.

Further, openings in the core support 63, 65, 67 and 69 are sized and aligned with the cores 134 and 136 such that a substantial volume of the supply airflow or the of the exhaust airflow passes therethrough.

The cores 134 and 136 are each provided with four rails 142 and 144, strips, tracks or the like (collectively termed “rails” for ease) preferably positioned along perimeter edges of the cores which, when the cores 134 and 136 are positioned within the housing 12, are perpendicular to the direction of the airflows and are adjacent the support means. The rails are provided with a contact surface 142a, 144a. The rails are formed from magnetisable metals or magnetic metal alloys, preferably ferromagnetic materials, more preferably ferromagnetic materials of high magnetic permeability. These metal rails may be attached to the heat or energy recovery core 134 and 136 using an adhesive sealant or other suitable fastening means. Additional sealant may be used to prevent air leakage. Preferably, the rails are L-shaped.

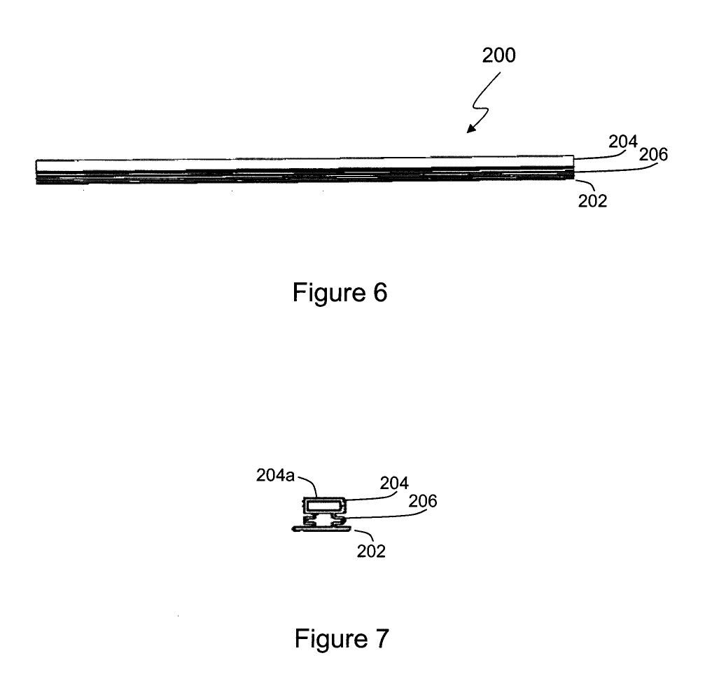

Gaskets 138 and 140 are provided on support means 146, 148, 150 and 152. As shown in FIGS. 6 and 7, the gaskets are magnetic gaskets 200 having a permanent magnet, each having a base portion for attachment to a support means. An elongated tube 204 is attached to the base portion by way of a resilient web 206. The web 206 is deformable upon compression of the tube 204 toward the base 202. Preferably, the tube 204, web 206 and base 202 are formed from a polymeric or elastomeric material. Preferably, the base is conformable to contact surfaces, for example, on support means or directly on interior walls of the housing, that may be irregular or uneven. Preferably, the tube 204 and web 206 are compressible and conformable against a contact surface of a rail 142 or 144 so as to form a removable and yet substantially air impermeable seal.

In cross-section, the elongated tube 204 may be rectangular in outline, shaped and sized to receive permanent magnets therein. The contact surface 204a of the tube 204 may be substantially flat and providing a sealing surface. Alternatively, the contact surface of the tube 204a may be mildly convex, providing a further deformable contact surface and thereby may provide a tighter seal when in contact with the contact surface 142a or 144a of a rail 142 or 144.

Alternatively, the elongated tube may be in the form of an elongated, tubular bead, with a convex contact surface. In cross-section, the tubular bead may form an oval, semi-circle, circle, or the like. Depending on the design and the application, the web 204 may not be necessary, particularly if additional resilience and compressibility is not required.

Permanent magnets may be inserted within the tube 204 or in the bead. The magnet may be flexible, for example, formed from a composite magnetic powder or granules with a polymeric or elastomeric binder, for example, PVC. The magnet may be a strip magnet, and may further be a multiple magnet for magnetic attraction in the direction of the contact surface of the gasket tube 204. The magnet may be a replaceable insert.

The magnetic gaskets may be secured to the support rails in alignment with the metal rails 142 and 144 provided on the cores 134 and 136 so as to magnetically contact and cooperate with the metal rails on the cores and thereby form an air tight seal.

The permanent magnet is selected to be of sufficient magnetic strength to form a seal with the metal rail.

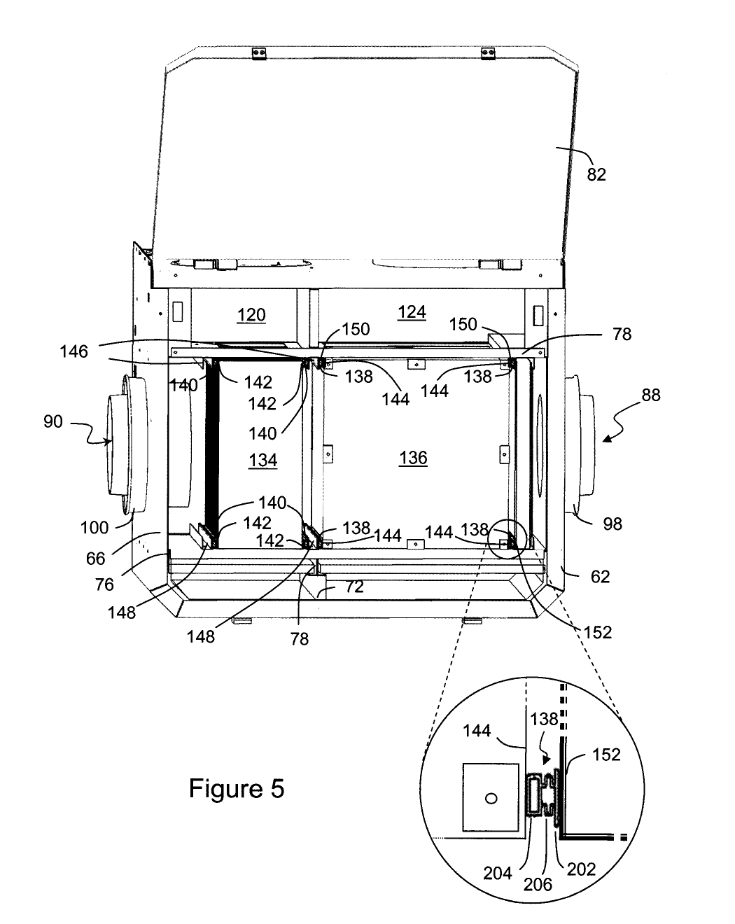

To minimize leakage and contamination, the magnetic gaskets should be in contact with the metal rails 142 and 144 along the full length of the edge of the cores 134 and 136, as depicted in FIGS. 4 and 5, and is preferably of unitary construction of sufficient length. Failure to do so may reduce the effectiveness of the seals and may lead to increased leakage and cross-contamination of airflows in the ventilation system.

Alternatively, the base portion 202 of the gasket may be mounted directly to housing at positions corresponding to the location and placement of the cores, for example, at positions on the top or bottom horizontal core supports 68 or 66. The base 202 may be attached by a variety of means including sealants, adhesives and fasteners.

Alternatively, the support means 146, 148, 150 and 152 may be provided with grooves or tracks for receiving complementary projections such as a boss, guide, dart, ridge, plates, or the like, provided on the underside of the base 202. Such corresponding grooves and projections may be mated, sized and shaped for retaining engagement of the gasket to the support means.

Alternatively, the support means 146, 148, 150 and 152 may be provided with a channel for receiving a complementary shaped base 202.

Alternatively, grooves, tracks or channels may be provided directly at positions on the top or bottom horizontal core supports 68 or 66, for receiving complementary or mated projections provided on the base or for receiving a complementary shaped base, for retaining engagement of the gasket to the housing 12.

As a further alternative, the metal railings on the energy cores 134 and 136 may be a permanent magnet. Instead of magnetic gaskets, the railing magnet may be aligned with and paired with a gaskets similar to that depicted in FIG. 7, but instead of a permanent magnet, the gasket may be provided with a magnetizable material within the tube 204. Such metal railings may be of flexible construction, or comprise powders or granules formed into a composite. Preferably, the materials comprise a ferromagnetic material, and more preferably a ferromagnetic material of high magnetic permeability. Alternatively, the contact surface of the gasket may be a composite comprising a magnetisable material, including ferromagnetic material, bound together with polymeric or elastomeric binders. In such a case, on alignment of magnet railings exerting sufficient magnetic force with such a gasket will effect magnetic attraction drawing the contact surface of the gasket to sealingly engage the magnet railings and form a seal.

The gaskets 138 and 140 and corresponding rails 142 and 144 on the perimeter edges of cores 134 and 136 may be positioned so as to form an air tight seal between the cores 134 and 136 and the adjacent walls (for example, top 68, bottom 66, back 70, door 82) where air leakage between the supply airflow and the return airflow may occur. It may be unnecessary to provide gaskets along perimeter edges of the cores where air leakage is minimal or unlikely to occur, for example, due to additional insulation or sealant on the door 82 and back panel 70.

As depicted in FIG. 6, a heat recovery core 134 and energy recovery core 136 have been placed within housing 12. The metal rails 142 and 144, as depicted in FIG. 4 are aligned with eight corresponding magnetic gaskets, 140 and 144, located on the support rails 146, 148, 150 and 152. Magnetic attractive forces in the magnetic gaskets form an air tight seal with the metal rails of the cores, thereby reducing the amount of leakage and contamination between the supply air flow and the return air flow through the ventilator. Upon exerting sufficient force to overcome the magnetic attractive force between the magnetic gasket and the correspondingly aligned metal rails, the energy cores 134 and 136 may be removed for maintenance, repair or replacement, as necessary.

While particular embodiments of the present invention have been shown and described, changes and modifications may be made to such embodiments without departing from the true scope of the invention, as would be apparent to one of skill in the art.

1. A heat or energy recovery core housing having a plurality of ports connectable to a plurality of ducts for conveying a fresh airflow and a return airflow therethrough, said fresh airflow and said return airflow each passing through at least one heat or energy recovery core for heat and optionally moisture exchange therebetween without mixing, said housing comprising at least one means for releasable sealing engagement of the at least one energy core to the housing and for providing an air tight seal between the at least one energy core and an interior of the housing, said sealing means positioned to prevent a leakage between the supply airflow and the exhaust airstream.

2. The housing according to claim 1, wherein the means for releasable sealing engagement comprises a magnetic gasket comprising a permanent magnet.

3. The housing according to claim 2, wherein the magnetic gasket comprises a base, an elongated tubular magnet retainer having a contact surface and the permanent magnet within said magnet retainer, said contact surface forming a seal when in magnetic cooperation with a magnetizable surface on the core.

4. The housing according to claim 3, wherein the contact surface is substantially flat and the gasket further comprises a web connecting the base to the magnet retainer.

5. The housing according to claim 2, wherein the magnetic retainer is circular, semicircular or oval in cross-section.

6. The housing according to claim 3, wherein the elongated tubular magnet retainer is rectangular or square in cross-section.

7. The housing according to claim 1, wherein the means for releasable sealing engagement comprises a magnetizable gasket.

8. The housing according to claim 7, wherein the gasket has a magnetizable contact surface.

9. The housing according to claim 7, wherein the gasket is partially or completely formed of ferromagnetic material.

10. The housing according to claim 1 further comprising means for retaining the at least one heat or energy recovery core within the housing in the flow path of the fresh airflow and the flow path of the return airflow.

11. The housing according to claim 10 wherein the housing includes a top horizontal core support, a bottom horizontal core support, a back wall and a door, and wherein the means for retaining the at least one heat or energy recovery core within the housing comprises at least one support means connected to the top core support for positioning a top part of the core within the housing and/or at least one bottom support means connected to the bottom core support for positioning a bottom part of the core within the housing.

12. (canceled)

13. A ventilation system comprising the housing according to claim 1, further comprising at least one removable heat or energy recovery core, said core having at least one metal railing positioned to align with at least one means for releasable sealing engagement for forming an airtight seal therebetween.

14. The system according to claim 13 wherein the railing is L-shaped.

15. The system according to claim 13 wherein the railing is formed of a magnetizable material.

16. (canceled)

17. A sealing system for an energy recovery ventilator housing having at least one energy recovery core within which heat and optionally moisture is exchanged between a supply airflow and a return airflow without mixing, said sealing system comprising a gasket having a sealing surface and a rail having a contact surface, said gasket attachable to an interior of the ventilator housing and said rail attachable to the at least one energy recovery core at a location in alignment with the gasket, the gasket and the rail, when positioned in alignment, magnetically cooperating thereby forming an airtight seal for preventing an air leakage between the supply airflow and the return airflow within the ventilator housing but outside of the at least one energy recovery core.

18. The system according to claim 17 wherein the gasket is a magnetic gasket having a permanent magnet.

19. The system according to claim 18, wherein the magnetic gasket comprises a base, an elongated tubular magnet retainer having the sealing surface and the permanent magnet within said magnet retainer.

20. The system according to claim 19 wherein the sealing surface is substantially flat and the gasket further comprising a web connecting the base to the magnet retainer.

21-27. (canceled)

28. The system according to claim 13 wherein the rail is a permanent magnet.

29-31. (canceled)

32. The system according to claim 17 including attachment means which cooperates with the gasket for releaseable attachment.
